(19) United States
(12) Patent Application Publication
(10) Pub. No.: US 2026/0162048 A1
(43) Pub. Date: Jun. 11, 2026

(54) DELIVERY SYSTEM TO PREVENT MISDELIVERY CLAIMS

(71) Applicant: Druglift Ventures LLC, Queens, NY (US)

(72) Inventor: Leo Gjoni, Bronx, NY (US)

(21) Appl. No.: 18/974,298

(22) Filed: Dec. 9, 2024

(51) Int. Cl. G06Q 10/083

(52) U.S. Cl. CPC G06Q 10/083

(57) ABSTRACT

A delivery system is provided for confirming that a product was delivered to the correct customer. The system involves the customer entering an acknowledgment of receipt on a computer device provided by a delivery agent. In response to the acknowledgment, the computer device captures an image of the customer's face. The captured image is then stored for future reference in case a misdelivery claim is later made.

### BACKGROUND

The present inventions relate generally to logistics, and more particularly, to a delivery system for providing products to customers.

More recently, it has become common for many products to be delivered directly to a customer's home. That is, while traditionally customers traveled to a brick and mortar store to purchase products, nowadays it has become common for customers to order products from a business (typically online). The business then ships the product to the customer's home, which eliminates the need for the customer to travel to a storefront in order to purchase a product. This new method of purchasing products has become so common because of its convenience for customers that it is imaginable that it may become the predominant means of purchasing products at some point in the future.

Nonetheless, delivering products to customers' homes presents unique challenges that do not arise or are less common with traditional storefront purchases. One problem involves ensuring that an ordered product is delivered to the correct customer home and preventing fraudulent claims that the product was misdelivered. That is, businesses that accept remote orders for products from customers frequently accept responsibility for ensuring that the product is actually received by the customer who placed the order. In most cases, businesses accept a certain level of risk that the customer may not actually receive the product that they ordered.

For example, it is common for delivery agents to leave an ordered product at the door of the house that the delivery agent believes belongs to the customer. If the delivery agent mistakenly leaves the product at the wrong house or a third party steals the product before the customer retrieves it, the business will commonly reimburse the customer for the price of the product and absorb the cost of the lost product. Sometimes a customer may even falsely report that they did not receive a product in order to fraudulently receive a reimbursement of the purchase price even though the customer actually did receive the product.

For the most part, there have been limited solutions to such product delivery problems. One solution has been for delivery agents to take a picture of the product as it is left next to the presumed customer's door so that, if a misdelivery claim is made by the customer, evidence can be provided of where the product was left. However, this solution cannot fully solve all the different causes for products not being received by customers (or allegedly not received) because there will always be some level of uncertainty about what happened to the product between the time that the delivery agent left the product at the customer's presumed home and when the customer had an opportunity to retrieve it.

Accordingly, the inventors believe that an improved system for delivering products to customers would be desirable.

### SUMMARY

A delivery system is described that can substantially reduce the number of misdelivery claims that are made. This may be especially useful in the delivery of prescription medicines, which can sometimes encourage unscrupulous or criminal individuals to make fraudulent misdelivery claims. In the delivery system, a delivery agent interacts directly with the customer and requests a signature on a computer device before providing the product to the customer. In addition, an image of the customer's face is captured in response the customer signing on a touchscreen of the computer device or in response to another acknowledgment of receipt. The invention may also include any other aspect described below in the written description or in the attached drawings and any combinations thereof.

### BRIEF DESCRIPTION OF SEVERAL VIEWS OF THE DRAWINGS

The invention may be more fully understood by reading the following description in conjunction with the drawing, in which:

FIG. 1 illustrates a schematic of a delivery system; and

FIGS. 2A-2C illustrate screens of an app that may be used in the delivery system.

### DETAILED DESCRIPTION

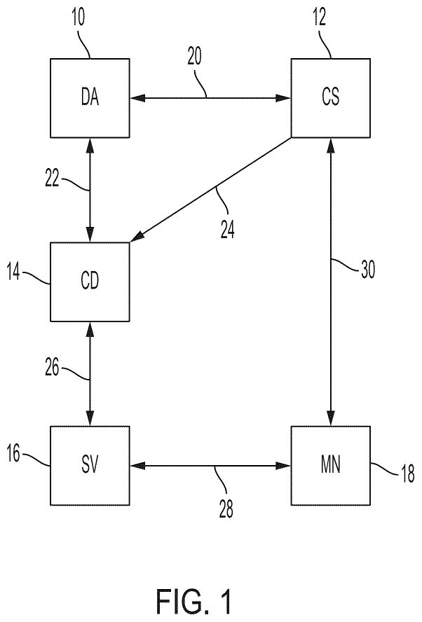

Referring now to the figures, and particularly FIG. 1, a system for delivering products to customers is shown. As shown, the system may involve a delivery agent 10, a customer 12, a computer device 14 (preferably a smart phone 14 or tablet 14), a remotely located server 16, and a delivery manager 18. Unlike conventional delivery systems, the delivery system described herein involves the delivery agent 10 directly interacting 20 with the customer 12. Ostensibly, this prevents a third party from stealing the product while it sits unattended next to the customer's door like in conventional delivery systems. In general, direct interaction 20 between the delivery agent 10 and the customer 12 should also prevent misdeliveries to the wrong home and similar such problems. However, even requiring direct interaction 20 between the delivery agent 10 and the customer 12 cannot completely prevent every possible misdelivery claim.

One area where misdelivery claims are especially troublesome is the delivery of prescription medicines. Certain prescription medicines are known to have addictive or other properties that make such products highly sought after by unethical or criminal individuals. Because of this, various schemes can be used to undermine conventional delivery systems. For example, in a simple scheme that can still be effective, the delivery agent 10 might hand the product directly to the actual customer 12, and yet, the next day the customer 12 could deceitfully claim that they did not receive the product. The delivery agent 10 might also deceitfully claim that they directly handed the product to the customer 12 when they actually only left the package at the customer's door. Thus, direct interaction 20 between the delivery agent 10 and the customer 12 cannot prevent all misdelivery claims. In the case of prescription medicines, misdelivery claims are particularly problematic because United States federal law requires a formal notice to be filed with the government each time that a prescription medicine is lost during delivery. This raises the administrative costs of delivering prescription medicines and implicates possible legal risks for the delivery service. Lost prescription medicines or fraudulent claims of lost prescription medicines also has the potential of supplying illicit and dangerous addictions.

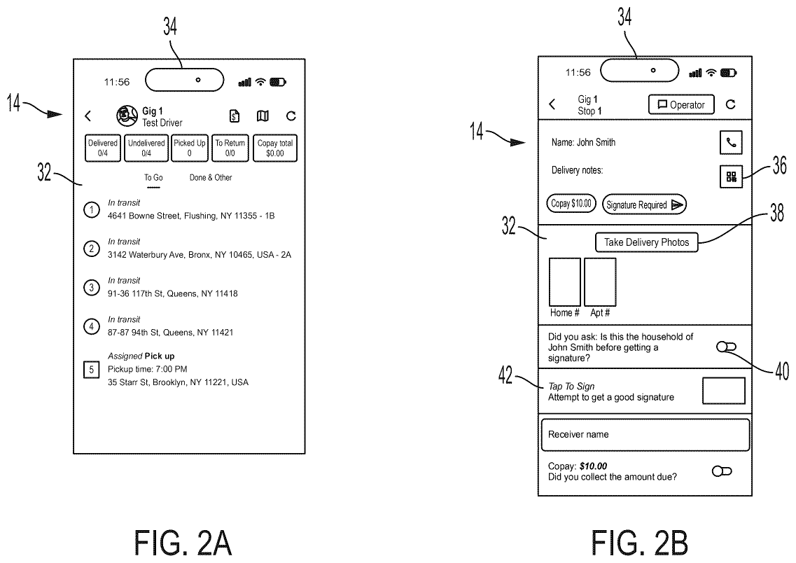

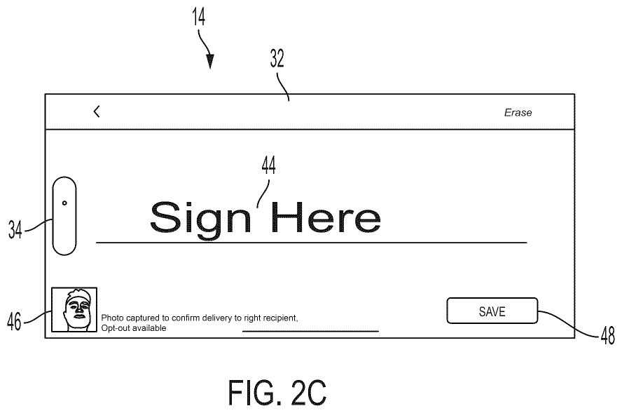

Turning back to FIG. 1, in the present delivery system, the delivery agent 10 is initially in possession of the product to be delivered and typically travels to the customer's home. Commonly, the delivery agent 10 may make a phone call to the customer 12 to ensure that they are home before traveling to the customer's home. When making deliveries, the delivery agent 10 also keeps the computer device 14 with them and interacts with the computer device 14 to schedule deliveries and enter data on completed deliveries 22. When the delivery agent 10 reaches the customer's home, the delivery agent 10 engages in a direct interaction 20 with the customer 12 and will typically orally confirm that the customer 12 is the actual customer who ordered the product. The delivery agent 10 then presents the computer device 14 to the customer 12. The computer device 14 preferably has a touchscreen 32 and a camera 34 (see FIGS. 2A-C) that faces in the same direction as the touchscreen 32 like a conventional smart phone 14 or tablet 14.

The customer 12 then contacts 24 the touchscreen 32 of the computer device 14 in a way that acknowledges receipt of the product. For instance, the acknowledgment 24 may be the customer 12 touching the touchscreen 32 with his or her finger or a stylus and using their finger or stylus to sign their name on the touchscreen 32. The customer's signature is then preferably stored for future reference in case the customer later makes a misdelivery claim. Even more preferably, the computer device 14 (and/or a delivery app loaded on the computer device 14, see FIGS. 2A-C) communicates wirelessly 26 with a remotely located server 16. In such an arrangement, it is preferable for the customer signature to be transmitted 26 from the computer device 14 to the server 16 and stored on the server 16.

Additionally, the computer device 14 automatically captures an image of the customer's face in response to the customer 12 contacting 24 the touchscreen 32 to acknowledge receipt of the product. This is done with the forward facing camera 34 of the computer device 14 (i.e., facing in the same direction of the touchscreen 32). As a result, the camera 34 will typically be naturally facing the customer's face as the customer 12 contacts 24 the touchscreen 32. Various methods may be used to time the instant of capturing an image of the customer's face. For example, the camera 34 may take a photo in response to the customer 12 first touching the touchscreen 32 to sign their name or may take a photo in response to the customer 12 last touching the touchscreen 32 after completing their signature. More preferably, the camera 34 may take multiple photos of the customer's face, e.g., by taking one photo at the start of the customer 12 entering their signature and another photo at the end of the customer 12 entering their signature. Automatic image capture may also involve a video segment of the customer's face while entering their signature.

Like the customer's signature, it is preferable for the captured image(s) of the customer's face to be stored for future reference. Preferably, this is done by transmitting 26 the image(s) from the computer device 14 to the server 16 and storing the image(s) on the server 16. After the customer 12 has acknowledged receipt of the product and the camera 34 has captured an image of the customer's face, the delivery agent 10 then provides 20 the customer 12 with the product and leaves the customer's home.

By using the delivery system as described, it is expected that misdelivery claims will be substantially reduced, and when made, will be resolved in a much more expedited way. For example, where the customer 12 is unscrupulous and later makes a fraudulent claim that they did not receive their ordered product, a manager 18 may respond 30 to the customer 12 by retrieving the stored acknowledgment signature and captured image of the customer's face and may show such evidence to the customer 12. This will usually quickly end such a misdelivery claim, with the customer 12 dropping the claim in light of the clear evidence showing that the customer 12 actually did receive the product. In the case of prescription medicine deliveries, an important additional advantage is that the formal government notice that must be filed when such medicines are lost during delivery may no longer need to be filed since the customer 12 will usually ultimately accept that the medicine was properly delivered.

Turning to FIGS. 2A-C, screens from a special app that may be used to perform the described system are shown. The app is preferably loaded onto the computer device 14 (e.g., smart phone 14 or tablet 14) and communicates 26 with the server 16 as described above. FIG. 2A shows a screen of the delivery app which lists the product deliveries that the delivery agent 10 is scheduled to make. FIG. 2B shows a screen for one of the scheduled deliveries. One of the features that the screen may provide is code scanning of the product to ensure that the delivery agent 10 provides the correct product to the customer 12. That is, when the delivery agent 10 presses the code scan button 36 on the touchscreen 32, the rear facing camera of the computer device 14 may be activated to scan a code (such as a QR code) that is affixed to the product which the delivery agent 10 intends to provide to the customer 12. The app may then communicate 26 with the server 16 to cross-reference the scanned code against an order database to check whether the scanned code matches the product that the customer ordered. The app may then indicate to the delivery agent 10 whether the scanned code matches the intended product or not. This may be done with a checkmark, a warning or other recognizable indicator. The delivery agent 10 may also manually take photos of the customer's home (e.g., door, porch, address number, etc.) in a conventional manner by pressing a photo button 38.

Another feature that may be provided in the screen of FIG. 2B is a button 40 to verify that the delivery agent 10 has confirmed that he or she is at the correct home by orally querying the customer 12 or another resident of the customer's home. Next, the screen of FIG. 2B may provide a Tap to Sign button 42 which initiates the customer signature process described above. That is, when the Tap to Sign button 42 is pressed, the app opens up the screen of FIG. 2C. As shown, a signature line 44 may be provided where the customer 12 may sign his or her name using a finger or stylus. As described above, the app also automatically captures one or more images of the customer's face as the customer 12 is signing their name on the touchscreen 32 of the computer device 14. As shown, it may be desirable to show the captured image 46 of the customer's face on the signature screen so that both the customer 12 and the delivery agent 10 can check the quality of the captured image 46. Finally, a Save button 48 may be provided to complete the signature and image capture.

By pressing the Save button 48, additional checks may be performed to prevent later misdelivery claims. For example, if the delivery service has a previously stored image of the customer's face on file, a facial recognition algorithm may be used to compare the captured image to the stored image to make sure that the two images match, which indicates that the presumed customer 12 with whom the delivery agent 10 is with is the actual customer 12 who should receive the product. The stored image may be obtained from an earlier delivery using the presently described image capture or may be separately provided to the delivery service by the customer 12, e.g., through a registration process. Preferably, the facial recognition algorithm is run on the server 16. Although it may be desirable to run the facial recognition algorithm after the customer 12 has entered their signature on the computer device 14 and the Save button 48 has been pressed, it may also be possible to run the facial recognition algorithm prior to pressing the Save button 48, for example, while the customer is signing.

It may also be desirable for the app to check whether an image of the customer's face has been captured in response to the Save button 48 being pressed. This allows the delivery agent 10 to ask the customer 12 to retry the signature in order to initiate the image capture again while the delivery agent 10 is still with the customer 12. Additionally, if the delivery system fails to capture an image of the customer's face, it may be desirable for the server 16 to issue a notice 28 that the delivery agent 10 delivered the product without obtaining an image of the customer's face. This allows a remotely located manager 18 to quickly contact 30 the customer 12, e.g., by phone, to confirm whether the customer 12 received the product or not. By recognizing this potential problem immediately in this manner, the manager 18 may also contact the delivery agent 10 while he or she is still in the vicinity to possibly retrieve the product if it was misdelivered and/or quickly alert the authorities if a more serious fraud is expected.

While preferred embodiments of the inventions have been described, it should be understood that the inventions are not so limited, and modifications may be made without departing from the inventions herein. While each embodiment described herein may refer only to certain features and may not specifically refer to every feature described with respect to other embodiments, it should be recognized that the features described herein are interchangeable unless described otherwise, even where no reference is made to a specific feature. It should also be understood that the advantages described above are not necessarily the only advantages of the inventions, and it is not necessarily expected that all of the described advantages will be achieved with every embodiment of the inventions. The scope of the inventions is defined by the appended claims, and all devices and methods that come within the meaning of the claims, either literally or by equivalence, are intended to be embraced therein.

1. A system in which a delivery agent delivers a product to a customer, comprising:
the delivery agent presenting a computer device to the customer, wherein the computer device comprises a touchscreen and a camera facing in the same direction as the touchscreen;
the customer contacting the touchscreen to acknowledge receipt of the product;
the computer device automatically capturing an image of a face of the customer with the camera in response to the customer contacting the touchscreen to acknowledge receipt of the product;
the delivery agent providing the customer with the product in response to the customer acknowledging receipt of the product by contacting the touchscreen;
storing the captured image of the customer's face for future reference; and
presenting the captured image of the customer's face when a misdelivery claim is made to thereby confirm that the product was correctly delivered to the customer.

2. The system according to claim 1, wherein the customer acknowledges receipt of the product by contacting the touchscreen to enter a signature belonging to the customer.

3. The system according to claim 2, further comprising storing the signature for future reference, and presenting the signature with the captured image of the customer's face when a misdelivery claim is made to thereby confirm that the product was correctly delivered to the customer.

4. The system according to claim 2, wherein the image of the customer's face is captured in response to a start of the customer entering the signature.

5. The system according to claim 2, wherein the image of the customer's face is captured in response to an end of the customer entering the signature.

6. The system according to claim 1, further comprising comparing the image of the customer's face with a stored image of the customer's face using a facial recognition algorithm to determine whether the image and the stored image match.

7. The system according to claim 1, wherein the product comprises a prescription medicine.

8. The system according to claim 1, further comprising the delivery agent scanning a code affixed to the product with the computer device, and the computer device indicating to the delivery agent on the touchscreen whether the scanned code matches the product intended for the customer.

9. The system according to claim 1, further comprising the computer device notifying the delivery agent if the image of the customer's face has not been captured in response to the customer acknowledging receipt of the product.

10. The system according to claim 1, further comprising an app configured to operate on a smartphone or tablet, the smartphone or tablet comprising the computer device, the app comprising a screen for the customer to acknowledge receipt of the product, and the app controlling the camera to capture the image of the customer's face.

11. The system according to claim 10, further comprising a server wirelessly communicating with the app, wherein the captured image is stored on the server.

12. The system according to claim 11, further comprising the app notifying the delivery agent if the image of the customer's face has not been captured in response to the customer acknowledging receipt of the product.

13. The system according to claim 12, further comprising a manager contacting the customer to confirm whether the customer received the product in response to the notice.

14. The system according to claim 13, wherein the product comprises a prescription medicine.

15. The system according to claim 11, wherein the product comprises a prescription medicine.

16. The system according to claim 15, wherein the customer acknowledges receipt of the product by contacting the touchscreen to enter a signature belonging to the customer in the screen of the app.

17. The system according to claim 16, further comprising storing the signature on the server for future reference, and presenting the signature with the captured image of the customer's face when a misdelivery claim is made to thereby confirm that the product was correctly delivered to the customer.

18. The system according to claim 17, wherein the image of the customer's face is captured in response to a start or an end of the customer entering the signature.

19. The system according to claim 17, further comprising comparing the image of the customer's face with a stored image of the customer's face using a facial recognition algorithm on the server to determine whether the image and the stored image match.

20. The system according to claim 19, further comprising the delivery agent scanning a code affixed to the product with the app, comparing the code with a stored code of the product intended for the customer on the server, and the app indicating to the delivery agent on the touchscreen whether the scanned code matches the product intended for the customer.
